(19) United States
(12) Patent Application Publication
(10) Pub. No.: US 2024/0305173 A1
(43) Pub. Date: Sep. 12, 2024

(54) CONTROL DEVICE AND COMMUNICATION METHOD IN CONTROL DEVICE

(71) Applicants: MITSUBA Corporation, Gunma (JP); Honda Motor Co., Ltd., Tokyo (JP)

(72) Inventors: MIYA YAMADA, Gunma (JP); KOTA FUKASHIRO, Gunma (JP); MASAHIRO FUEKI, Gunma (JP); KEIICHI MORI, Gunma (JP); YUJI MINODA, Tokyo (JP)

(73) Assignees: MITSUBA Corporation, Gunma (JP); Honda Motor Co., Ltd., Tokyo (JP)

(21) Appl. No.: 18/542,753

(22) Filed: Dec. 17, 2023

(30) Foreign Application Priority Data
Mar. 8, 2023 (JP) 2023-035770

(51) Int. Cl. H02K 11/35; G06K 7/00

(52) U.S. Cl. CPC H02K 11/35; G06K 7/0021

(57) ABSTRACT

A motor control device includes an MCU and a predriver configuring at least a part of a circuit for controlling driving of a motor. The MCU includes a communication timing judgment portion, judging whether or not a timing is to execute a communication between the MCU and the predriver and outputting a communication execution command when the timing is judged to be a timing to execute the communication between the MCU and the predriver; and a communication portion, executing the communication between the MCU and the predriver when the communication execution command is input. The communication timing judgment portion judges a timing that does not overlap with a timing at which noise occurs due to a factor other than the communication between the MCU and the predriver as the timing to execute the communication between the MCU and the predriver.

### CROSS-REFERENCE TO RELATED APPLICATION

This application claims the priority benefits of Japanese application no. 2023-035770, filed on Mar. 8, 2023. The entirety of the above-mentioned patent application is hereby incorporated by reference herein and made a part of this specification.

### BACKGROUND

### Technical Field

The disclosure relates to a control device and a communication method in a control device.

### Description of Related Art

In a motor driving system with an MCU (micro controller unit) and IC (integrated circuit) on the same system, the MCU and IC periodically execute communication (specifically, for example, SPI (serial peripheral interface) communication), for example, to write IC settings and read IC fail information (see, for example, Patent Document 1 (Japanese Patent Application Laid-Open (JP-A) No. 2014-89672)).

Meanwhile, noise oscillation occurs during communication, and depending on the frequency and conditions of the occurrence of noise oscillation, the noise oscillation accompanying communication may cause electromagnetic interference. This poses a problem in that electronic devices may have many harmful consequences, such as malfunctions, reduced functionality, loss of data, and safety risks.

Accordingly, one aspect of the disclosure is to provide a technology that may reduce noise oscillations caused by communication on the same system.

### SUMMARY

The control device of the disclosure may include: an MCU and an IC. The MCU may include: a communication timing judgment portion, judging whether or not a timing is to execute a communication between the MCU and the IC and outputting a communication execution command when the timing is judged to be a timing to execute the communication between the MCU and the IC; and a communication portion, executing the communication between the MCU and the IC when the communication execution command is input. The communication timing judgment portion may judge a timing that does not overlap with a timing at which noise occurs due to a factor other than the communication between the MCU and the IC as the timing to execute the communication between the MCU and the IC.

The control device according to the disclosure may be configured such that the MCU and the IC configure at least a part of a circuit for controlling driving of a motor and the timing that does not overlap with the timing at which noise occurs due to the factor other than the communication between the MCU and the IC is a timing at which a stop command of the motor is input from an ECU, which is an upper control device of the MCU and the IC, to the communication timing judgment portion of the MCU.

The control device according to the disclosure may include: an MCU and an IC. The MCU may include: a traffic comparison portion, comparing a traffic required to write settings of the IC (referred to as “writing traffic”) and a traffic required to read current settings of the IC (referred to as “reading traffic”), outputting a communication execution command when the reading traffic is heavier than the writing traffic, and outputting a reading execution command to read a content of the current settings of the IC when the reading traffic is less than the writing traffic; a setting content judgment portion, judging whether or not a content of the read current settings of the IC is normal and outputting a communication execution command when the content of the current settings of the IC is abnormal; and a communication portion, executing a communication between the MCU and the IC for reading the current settings of the IC when the reading execution command is input and executing the communication between the MCU and the IC for writing the settings of the IC when the communication execution command is input.

The control device according to the disclosure may be configured such that the MCU and the IC configure at least a part of a circuit for controlling driving of a motor.

The communication method in the control device according to the disclosure is a method executed by a control device including an MCU and an IC, the method may include: a step of judging whether or not a timing is to execute a communication between the MCU and the IC; and a step of executing the communication between the MCU and the IC when the timing is judged to be a timing to execute the communication between the MCU and the IC. A timing that does not overlap with a timing at which noise occurs due to a factor other than the communication between the MCU and the IC may be judged as the timing to execute the communication between the MCU and the IC.

The communication method in the control device according to the disclosure may be configured such that the MCU and the IC configure at least a part of a circuit for controlling driving of a motor and the timing that does not overlap with the timing at which noise occurs due to the factor other than the communication between the MCU and the IC is a timing at which a stop command of the motor is input from an ECU, which is an upper control device of the MCU and the IC, to the MCU.

The communication method in the control device according to the disclosure is a method executed by a control device including an MCU and an IC, the method may include: a step of comparing a traffic required to write settings of the IC (referred to as “writing traffic”) and a traffic required to read current settings of the IC (referred to as “reading traffic”); a step of executing a communication between the MCU and the IC for writing the settings of the IC when the reading traffic is heavier than the writing traffic; a step of executing the communication between the MCU and the IC for reading the current settings of the IC when the reading traffic is less than the writing traffic; a step of judging whether or not a content of the read current settings of the IC are normal; and a step of executing the communication between the MCU and the IC for writing the settings of the IC when the content of the read current settings of the IC is abnormal.

The communication method in the control device according to the disclosure may be configured such that the MCU and the IC configure at least a part of a circuit for controlling driving of a motor.

According to one aspect of the disclosure, noise oscillations caused by communication on the same system may be reduced.

### BRIEF DESCRIPTION OF THE DRAWINGS

FIG. 1 is a block diagram showing an example of the configuration of the motor control device according to the embodiment of the disclosure, in which the communication method in the motor control device according to the embodiment of the disclosure is executed.

FIG. 2 is a diagram showing the functional configuration of the MCU of the motor control device according to the first embodiment.

FIG. 3 is a diagram showing the processing content of the motor control device and the communication method in the motor control device according to the first embodiment.

FIG. 4 is a diagram showing the functional configuration of the MCU of the motor control device according to the second embodiment.

FIG. 5 is a diagram showing the processing content of the motor control device and the communication method in the motor control device according to the second embodiment.

FIG. 6 is a flowchart showing the processing procedure of the motor control device and the communication method in the motor control device according to the second embodiment.

FIG. 7 is a diagram showing the functional configuration of the MCU of the motor control device according to the third embodiment.

FIG. 8A is a diagram showing the processing content of the motor control device and the communication method in the motor control device according to the third embodiment.

FIG. 8B is a diagram showing the processing content of the motor control device and the communication method in the motor control device according to the third embodiment.

FIG. 9 is a flowchart showing the processing procedure of the motor control device and the communication method in the motor control device according to the third embodiment.

### DESCRIPTION OF THE EMBODIMENTS

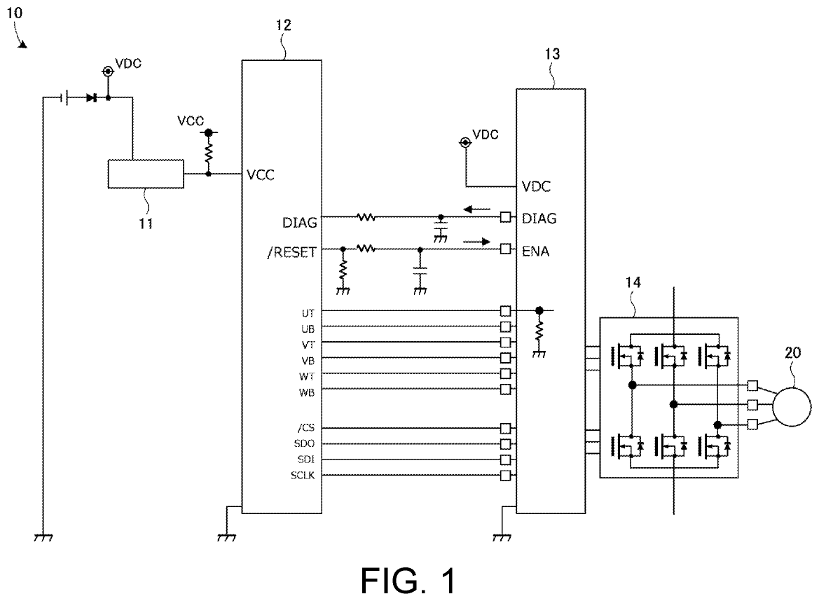

The embodiments of the disclosure will be described below with reference to the drawings. In the following embodiments (specifically, the first embodiment to the third embodiment), the communication method in the control device according to the disclosure will be described using the case in which the method is executed in an exemplary control device according to the disclosure shown in FIG. 1.

### Configuration of Device

FIG. 1 is a block diagram showing an example of the configuration of the motor control device 10 according to the embodiment, in which the communication method in the motor control device according to the embodiments (specifically, the first embodiment to the third embodiment) is executed, as an example of the specific configuration aspect of the control device and the communication method in the control device according to the disclosure.

The motor control device 10 according to the embodiment is a mechanism for controlling the driving of a three-phase AC motor 20 (three phases: U phase, V phase, and W phase) mounted on a vehicle. Specifically, the three-phase AC motor 20 is a motor that drives an electric oil pump that circulates oil. Here, devices and circuits (i.e., control device in the disclosure) to which the communication method in the control device of the disclosure may be applied are not limited to devices and circuits for controlling the driving of motors, and the motor control device 10 shown in FIG. 1 is only one example of a device or circuit to which the communication method in the control device of the disclosure may be applied, so a detailed description is omitted, but the outline is as follows.

The motor control device 10 includes a power supply circuit 11, an MCU (micro controller unit) 12, a predriver 13, and a FET (field effect transistor) bridge 14.

The power supply circuit 11 generates direct current power supply voltage VCC and VDC. The direct current power supply voltage VCC is the power supply voltage (power supply potential) for the MCU 12, and is supplied to the terminal VCC of the MCU 12. The direct current power supply voltage VDC is the power supply voltage (driving voltage) for driving the inverter of the three-phase AC motor 20, and is supplied to the terminal VDC of the predriver 13.

The MCU 12 is, for example, configured as a chip including a CPU (central processing unit), a memory, etc. The CPU of the MCU 12 is configured to read programs and data stored in the memory and perform predetermined processing.

The MCU 12 generates control signals UT, UB, VT, VB, WT, and WB and supplies the same to the predriver 13. The control signals UT and UB are signals for controlling ON/OFF of the switching element related to the U phase in the FET bridge 14. The control signals VT and VB are signals for controlling ON/OFF of the switching element related to the V phase in the FET bridge 14. The control signals WT and WB are signals for controlling ON/OFF of the switching element related to the W phase in the FET bridge 14.

The predriver 13 corresponds to a driving circuit for driving the switching element in the FET bridge 14, and is configured by an IC (integrated circuit). The predriver 13 supplies the signal for controlling each of the switching elements generated according to the control signals UT, UB, VT, VB, WT, and WB supplied from the MCU 12 to the control terminal of each of the switching elements of the FET bridge 14 via six output terminals. That is, the predriver 13 controls the switching operation (i.e., ON/OFF) of the six switching elements in the FET bridge 14 based on the control signals UT, UB, VT, VB, WT, and WB supplied from the MCU 12.

The FET bridge 14 drives the three-phase AC motor 20 by the inverter according to the signal for controlling the switching operation (i.e., ON/OFF) of the six switching elements supplied from the predriver 13 through the six input terminals. The FET bridge 14 is provided with six switching elements for driving the three-phase AC motor 20 by the inverter, specifically, three upper arm (high side) switching elements located at the upper side of the bridge circuit and three lower arm (low side) switching elements located at the lower side of the bridge circuit are provided. Each of the switching elements is configured by a field effect transistor (FET). The three output terminals of the FET bridge 14 are connected to the three coils (i.e., U-phase coil, V-phase coil, and W-phase coil; not shown in the figure) of the three-phase AC motor 20, respectively.

The MCU 12 and the predriver 13 execute communication, and specifically, for example, execute SPI (serial peripheral interface) communication. In the example shown in FIG. 1, four-wire SPI communication is executed with the MCU 12 as the SPI main (or SPI master) and the predriver 13 as the SPI sub node (or SPI slave).

In this case, as the communication signals, a signal/CS for chip selection (/represents—added above CS), a signal SDI for main output-sub node input, and a clock signal SCLK generated by the MCU 12 for synchronizing the communication are transmitted from the MCU 12 as the SPI main to the predriver 13 as the SPI sub node. Further, a signal SDO for main input-sub node output is transmitted from the predriver 13 as the SPI sub node to the MCU 12 as the SPI main.

The signal SDI for main output-sub node input is data from the MCU 12 (SPI main) to the predriver 13 (SPI sub node) for controlling the switching operation of the six switching elements in the FET bridge 14 in the predriver 13. The signal SDO for the main input-sub node output is data from the predriver 13 (SPI sub node) to the MCU 12 (SPI main).

Furthermore, a diagnostic signal DIAG is transmitted from the predriver 13 to the diagnostic terminal DIAG of the MCU 12. The diagnostic signal DIAG is, for example, an electrical signal corresponding to information (also referred to as “fail information” or “diagnostic information”) indicating an abnormality in the three-phase AC motor 20. Furthermore, when the diagnostic signal DIAG is input, the ECU (electronic control unit; not shown in FIG. 1), which is the upper control device of the MCU 12 and the predriver 13, checks the content of the diagnostic signal DIAG, for example, depending on whether the signal is a diagnostic signal (fail information) indicating a minor abnormality or a diagnostic signal (fail information) indicating an abnormality that requires immediate protection, etc., and performs fail-safe processing or other processing or control.

Further, a reset signal/RESET (/represents—added above RESET) is transmitted from the MCU 12 to an enable terminal ENA of the predriver 13. For example, when restoring the predriver 13 or the three-phase AC motor 20 to the original state, a reset signal/RESET is applied from the MCU 12 to the enable terminal ENA of the predriver 13.

Here, the MCU 12 executes writing of the settings (e.g., energization method settings, fault settings related to abnormality detection functions (enable/disable settings for overheat, undervoltage, gate drive, watchdog, etc.), overcurrent (Vds) abnormality detection threshold value, notification method, setting of sensing invalid time) of the predriver 13 once when the system (specifically, the motor control device 10) is powered on or before the start of operation. Then, for example, when the predriver 13 is reset caused by power supply voltage fluctuation while the system is operating, the initialization settings (specifically, the same settings as when power supply is turned on) need to be performed again. However, the power supply voltage fluctuation may occur at any time. Thus, in order to respond to the reset of the predriver 13 caused by the power supply voltage fluctuation at an early stage (specifically, initialization settings), which may occur at any time, a communication between the MCU 12 and the predriver 13 may be periodically executed to write the settings of the predriver 13.

In addition, by configuring the MCU 12 to be able to communicate with the IC (i.e., IC corresponding to the predriver 13 in this embodiment), the settings of the IC may be rewritten and changed as needed to match, for example, the specifications of the mechanism or equipment controlled by the motor control device 10, the specifications of the mechanism or equipment associated with the motor control device 10, or the state under which the system is operating.

However, noise oscillation occurs during communication, and the noise oscillation accompanying communication during system operation may cause electromagnetic interference. Thus, in order to reduce noise oscillation caused by communication, the disclosure limits the timing of executing communication (the first embodiment), prohibits unnecessary communication with heavy traffic (the second embodiment), and limits the timing of executing communication and prohibits unnecessary communication (the third embodiment).

### The first embodiment

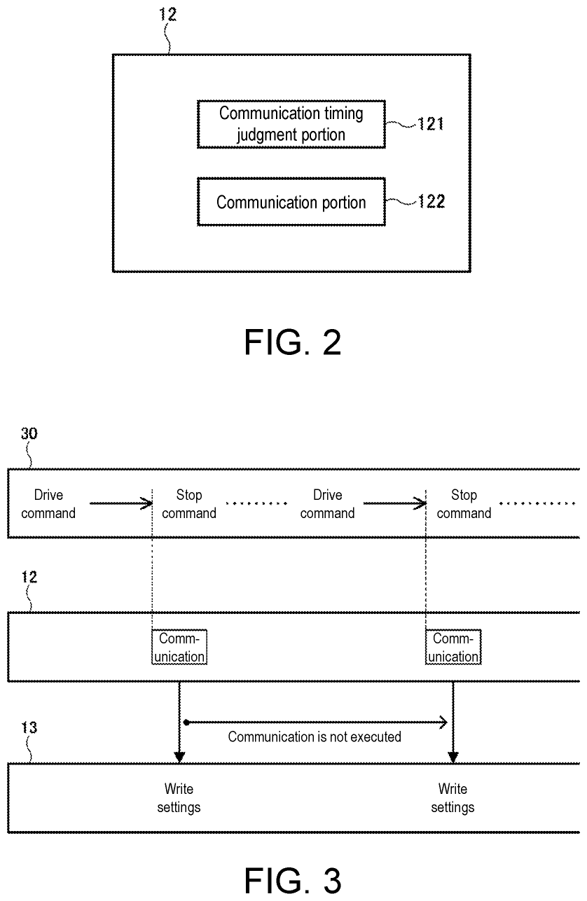

FIG. 2 is a diagram showing the functional configuration of the MCU 12 of the motor control device 10 according to the first embodiment, as an example of the specific configuration aspect of the control device according to the disclosure. FIG. 3 is a diagram showing the processing content of the motor control device 10 and the communication method in the motor control device according to the first embodiment, as an example of the specific configuration aspect of the control device and the communication method in the control device according to the disclosure.

The motor control device 10 according to the first embodiment of the disclosure includes the MCU 12 and the predriver 13 configuring at least a part of a circuit for controlling driving of a motor. The MCU 12 includes a communication timing judgment portion 121, judging whether or not a timing is to execute the communication between the MCU 12 and the predriver 13 and outputting a communication execution command when the timing is judged to be a timing to execute the communication between the MCU 12 and the predriver 13; and a communication portion 122, executing the communication between the MCU 12 and the predriver 13 when the communication execution command is input. The communication timing judgment portion 121 judges a timing that does not overlap with a timing at which noise occurs due to a factor other than the communication between the MCU 12 and the predriver 13 as the timing to execute the communication between the MCU 12 and the predriver 13.

Further, the communication method in the motor control device according to the first embodiment of the disclosure is a method executed by a motor control device including an MCU 12 and a predriver 13, the method includes: a step of judging whether or not a timing is to execute the communication between the MCU 12 and the predriver 13; and a step of executing the communication between the MCU 12 and the predriver 13 when the timing is judged to be a timing to execute the communication between the MCU 12 and the predriver 13. A timing that does not overlap with a timing at which noise occurs due to a factor other than the communication between the MCU 12 and the predriver 13 is judged as the timing to execute the communication between the MCU 12 and the predriver 13.

In this embodiment, at the timing when the stop command (specifically, an electrical signal corresponding to the stop command) of the three-phase AC motor 20 is input from the ECU 30, which is the upper control device of the MCU 12 and the predriver 13, to the communication timing judgment portion 121 of the MCU 12, a communication execution command is output from the communication timing judgment portion 121 and input to the communication portion 122 of the MCU 12, and the communication between the MCU 12 and the predriver 13 is executed by the communication portion 122 and the writing of settings from the MCU 12 to the predriver 13 is executed. Then, after communication is executed at the timing when the stop command of the three-phase AC motor 20 is transmitted from the ECU 30, the communication between the MCU 12 and the predriver 13 related to the writing of the settings of the predriver 13 is not executed until the ECU 30 transmits the next stop command of the three-phase AC motor 20 (after the ECU 30 transmits a drive command of the three-phase AC motor 20).

For example, when an abnormality such as the three-phase AC motor 20 rotates too much or is not rotating and the ECU 30 detects the abnormality, the ECU 30 transmits the stop command, and at this timing, the communication between the MCU 12 and the predriver 13 is executed and settings are written from the MCU 12 to the predriver 13.

The timing that executes the communication between the MCU 12 and the predriver 13 (in other words, the trigger) is not limited to the timing when the stop command of the three-phase AC motor 20 is transmitted from the ECU 30, any timing that does not pose a problem even if electromagnetic wave noise accompanying communication is emitted may be used. Specifically, the communication between the MCU 12 and the predriver 13 may be executed at a timing that avoids the noise generated by the communication between the MCU 12 and the predriver 13 from competing with the noise generated by other factors. In other words, the communication between the MCU 12 and the predriver 13 is executed at a timing that does not overlap with a timing at which noise occurs due to a factor other than the communication. That is, the communication timing judgment portion 121 of the MCU 12 judges a timing that does not overlap with a timing at which noise occurs due to a factor other than the communication between the MCU 12 and the predriver 13 as the timing to execute the communication between the MCU 12 and the predriver 13.

In this embodiment, while the three-phase AC motor 20 is driven, since the noise is generated with the predriver 13 as a factor, the communication between the MCU 12 and the predriver 13 is not executed to avoid competing with the noise, and the communication is executed because there is no noise generated with the predriver 13 as a factor when the three-phase AC motor 20 is stopped. Then, the communication timing judgment portion 121 of the MCU 12 judges the timing at which the ECU 30 transmits the stop command of the three-phase AC motor 20 as the timing to execute the communication between the MCU 12 and the predriver 13 (accordingly, outputs the communication execution command).

Also, when the circuit (in particular, a combination of the MCU 12 and an IC that executes communication with that MCU 12 (i.e., an IC corresponding to the predriver 13 in this embodiment)) controls other mechanism or equipment, at a timing that does not pose a problem even if electromagnetic wave noise accompanying communication is emitted corresponding to each of the mechanism or equipment to be controlled, that is, at the timing that avoids noise caused by the communication between the MCU 12 and the IC competing with noise caused by other factors, in other words, the communication between the MCU 12 and the IC is executed at the timing that does not overlap with the timing at which noise occurs due to a factor other than the communication between the MCU 12 and the IC.

For example, the combination of the MCU and IC is responsible for the display function of a clock or other information displayed on a display installed in an instrument panel of a vehicle, and in the case of a system in which display switching and resting (not sleep function) are alternately repeated, the communication between the MCU and the IC may be executed at the timing of resting (i.e., after one display switching and before the next display switching) when the clock or other display function is not in operation.

In addition, in the case of a system that implements a sleep function in the MCU, since there is a time before and after the sleep when the function related to the MCU does not operate, the communication between the MCU and the IC may be performed between the time when the ignition (i.e., the MCU power supply) is turned off and sleep and when the ignition (the MCU power supply) is turned on and wake-up.

### The Second Embodiment

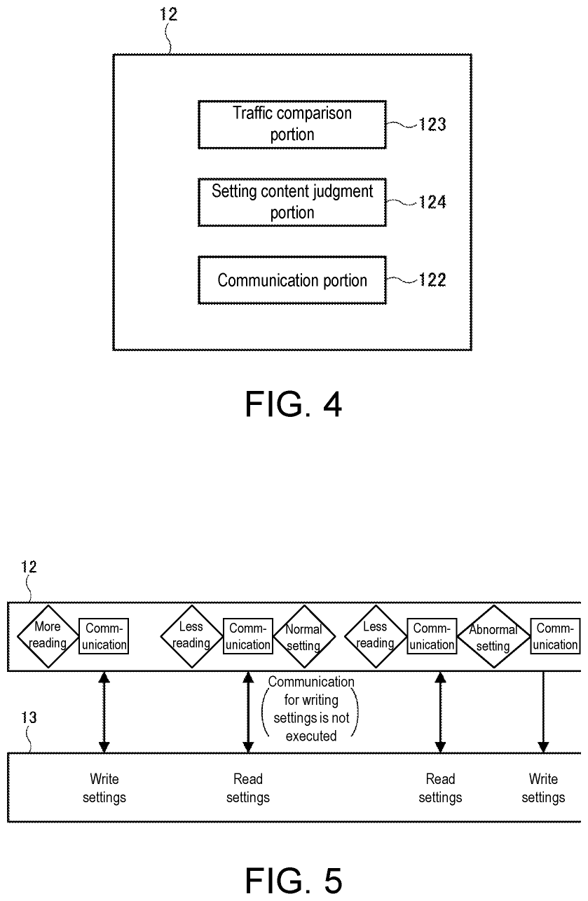

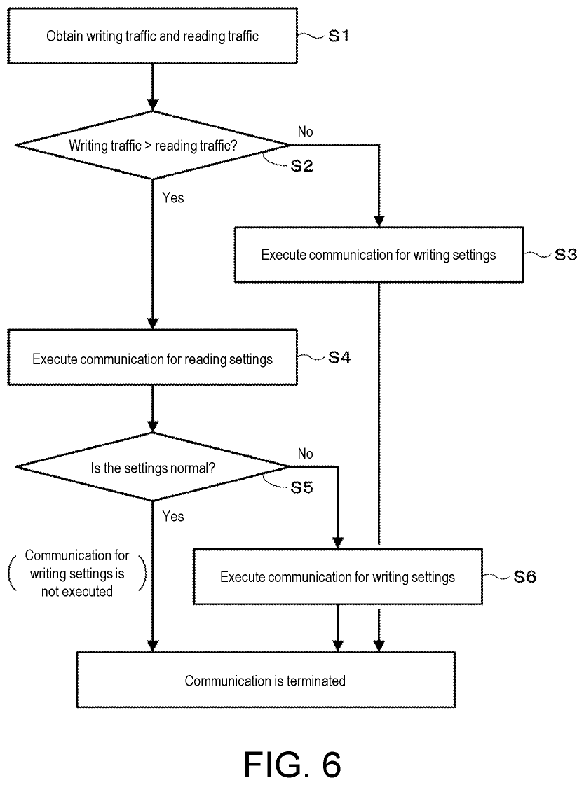

FIG. 4 is a diagram showing the functional configuration of the MCU 12 of the motor control device 10 according to the second embodiment, as an example of the specific configuration aspect of the control device according to the disclosure. FIG. 5 is a diagram showing the processing content of the motor control device 10 and the communication method in the motor control device according to the second embodiment, as an example of the specific configuration aspect of the control device and the communication method in the control device according to the disclosure. FIG. 6 is a flowchart showing the processing procedure of the motor control device 10 and the communication method in the motor control device according to the second embodiment.

The motor control device 10 according to the second embodiment of the disclosure includes the MCU 12 and the predriver 13 configuring at least a part of a circuit for controlling driving of a motor. The MCU 12 includes a traffic comparison portion 123, comparing a traffic required to write settings of the predriver 13 (referred to as “writing traffic”) and a traffic required to read current settings of the predriver 13 (referred to as “reading traffic”), outputting a communication execution command when the reading traffic is heavier than the writing traffic, and outputting a reading execution command to read a content of the current settings of the predriver 13 when the reading traffic is less than the writing traffic; a setting content judgment portion 124, judging whether or not a content of the read current settings of the predriver 13 is normal and outputting a communication execution command when the content of the current settings of the predriver 13 is abnormal; and a communication portion 122, executing the communication between the MCU 12 and the predriver 13 for reading the current settings of the predriver 13 when the reading execution command is input and executing the communication between the MCU 12 and the predriver 13 for writing the settings of the predriver 13 when the communication execution command is input.

Further, the communication method in the motor control device according to the second embodiment of the disclosure is a method executed by a motor control device including an MCU 12 and a predriver 13, the method includes: steps S1 and S2 of comparing a traffic required to write settings of the predriver 13 (referred to as “writing traffic”) and a traffic required to read current settings of the predriver 13 (referred to as “reading traffic”); a step S3 of executing the communication between the MCU 12 and the predriver 13 for writing the settings of the predriver 13 when the reading traffic is heavier than the writing traffic (step S2: No); a step S4 of executing the communication between the MCU 12 and the predriver 13 for reading the current settings of the predriver 13 when the reading traffic is less than the writing traffic (step S2: Yes); a step S5 of judging whether or not a content of the read current settings of the predriver 13 are normal; and a step S6 of executing the communication between the MCU 12 and the predriver 13 for writing the settings of the predriver 13 when the content of the read current settings of the predriver 13 is abnormal (step S5: No).

In this embodiment, verification is performed to judge whether or not the communication between the MCU 12 and the predriver 13 is to be executed, and based on the results of the verification, the communication between the MCU 12 and the predriver 13 is executed as necessary to execute writing of the settings from the MCU 12 to the predriver 13.

Specifically, first, the traffic comparison portion 123 of the MCU 12 obtains the traffic required to write the settings of the predriver 13 (i.e., writing traffic) and the traffic required to read the current settings (register) of the predriver 13 (i.e., reading traffic) (step S1).

The writing traffic and the reading traffic may be grasped, for example, at the design stage of the motor control device 10. In other words, when executing the writing of the settings of the predriver 13, the communication is executed with the registers of the predriver 13 and signals are transmitted from the MCU 12, and the writing is executed for multiple registers according to the setting items. Then, communication (specifically, for example, SPI communication) is transmitted one by one for each register. For this reason, since the number of registers to be set becomes the writing traffic (i.e., the number of communications), the writing traffic is determined by designing the number of registers to be set. Similarly, the reading traffic is determined by designing the number of registers to be read. If it is possible to judge from the writing traffic and the reading traffic estimated at the design stage which of the traffic of the writing traffic and the reading traffic is heavier, instead of processing step S1, it may be designed such that the communication for writing the settings of the predriver 13 is executed when the writing traffic is less than the reading traffic, and the communication for reading the current settings of the predriver 13 is executed when the writing traffic is heavier than the reading traffic. Further, the writing traffic and the reading traffic in the communication between the MCU 12 and the predriver 13, which are determined and grasped at the design stage of the motor control device 10, are stored in advance in, for example, the memory in the MCU 12, and as the process of step S1, the stored writing traffic and reading traffic may be read.

Here, the timing to obtain the writing traffic and the reading traffic (accordingly, the timing to execute the communication between the MCU 12 and the predriver 13 as necessary) may be performed at predetermined intervals, or may be performed according to a predetermined trigger.

Next, the traffic comparison portion 123 of the MCU 12 compares the writing traffic and the reading traffic obtained in step S1 and judges whether or not the reading traffic is less than the writing traffic (step S2).

As mentioned above, since the writing traffic and reading traffic are determined and grasped at the design stage of the motor control device 10, the magnitude relationship between the writing traffic and the reading traffic in the communication between the MCU 12 and the predriver 13, which are determined and grasped at the design stage of the motor control device 10, is stored in advance in, for example, the memory in the MCU 12, and as the process of step S2, the stored magnitude relationship may be read. Based on this, the process of step S1 and the process of step S2 may be substantially executed as a single process.

Then, when the reading traffic is heavier than the writing traffic (step S2: No), the communication execution command is output from the traffic comparison portion 123 of the MCU 12 and input to the communication portion 122 of the MCU 12, and the communication portion 122 executes the communication between the MCU 12 and the predriver 13 to write the settings of the predriver 13 (step S3). As a result, the communication between the MCU 12 and the predriver 13 corresponding to the timing according to the predetermined interval, trigger (step S1) is terminated.

On the other hand, when the reading traffic is less than the writing traffic (step S2: Yes), the reading execution command is output from the traffic comparison portion 123 of the MCU 12 and input to the communication portion 122 of the MCU 12, and the communication portion 122 executes the communication between the MCU 12 and the predriver 13 to read the current settings of the predriver 13 (step S4). Then, the content of the read current settings of the predriver 13 is transmitted to the setting content judgment portion 124 of the MCU 12.

After that, the setting content judgment portion 124 of the MCU 12 judges whether or not the read setting content is normal (step S6). The setting content judgment portion 124, for example, judges the read setting content to be normal when the register value (specifically, 1 or 0) matches the value that should be set in the current situation and judges the read setting content to be abnormal when the register value does not match the value that should be set in the current situation.

Specifically, the setting content judgment portion 124 may, for example, judge whether or not the read setting content is normal based on whether or not the content set for the predriver 13 when the power supply is turned on is retained as the same. It should be noted that when a malfunction or error occurs in the predriver 13, the content set for the predriver 13 when power supply is turned on changes. For example, when the power supply voltage of the predriver 13 fluctuates while the power supply voltage of the MCU 12 is not abnormal, the content set for the predriver 13 when the power supply is turned on is reset and changed by resetting the predriver 13.

In addition, based on a comparison with the proper content (in other words, content that should be set) at each time point when the system is operating, it may be judged whether or not the read setting content is normal.

Then, when the read setting content is abnormal (step S5: No), the communication execution command is output from the setting content judgment portion 124 of the MCU 12 and input to the communication portion 122 of the MCU 12, and the communication portion 122 executes the communication between the MCU 12 and the predriver 13 to write the settings of the predriver 13 (step S6). As a result, the communication between the MCU 12 and the predriver 13 corresponding to the timing according to the predetermined interval, trigger (step S1) is terminated.

On the other hand, when the read setting content is normal (step S5: Yes), the communication between the MCU 12 and the predriver 13 for writing the settings of the predriver 13 is not executed, and the communication between the MCU 12 and the predriver 13 corresponding to the timing according to the predetermined interval, trigger (step S1) is terminated.

### The Third Embodiment

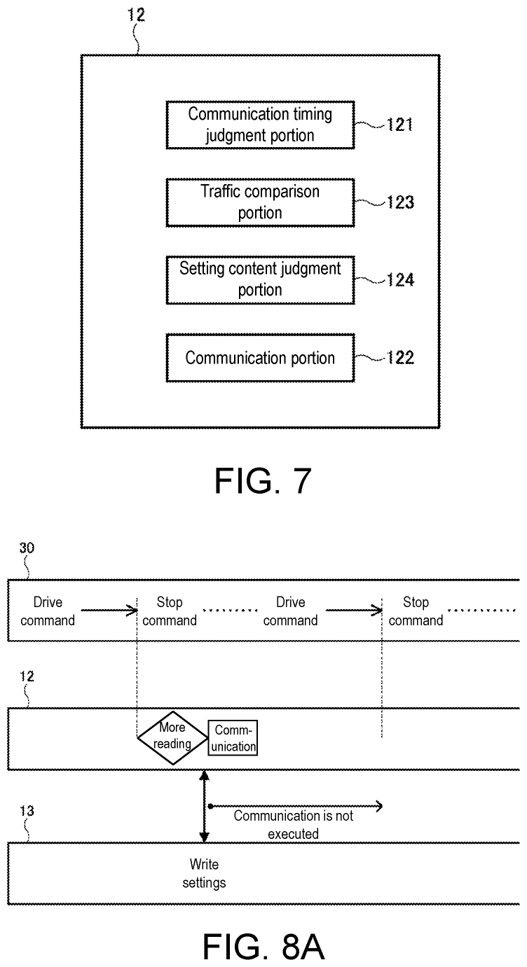

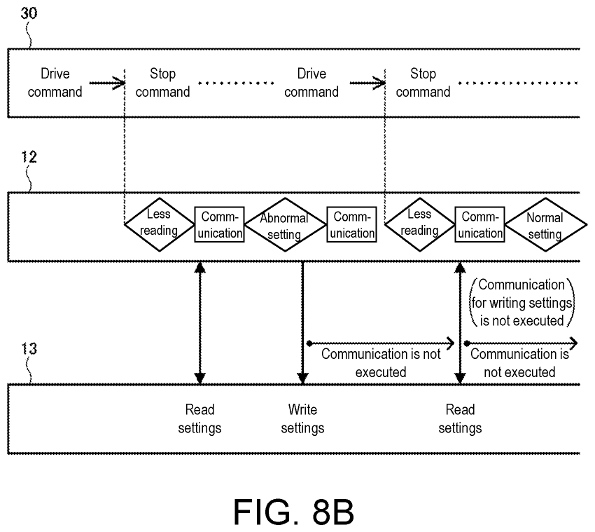

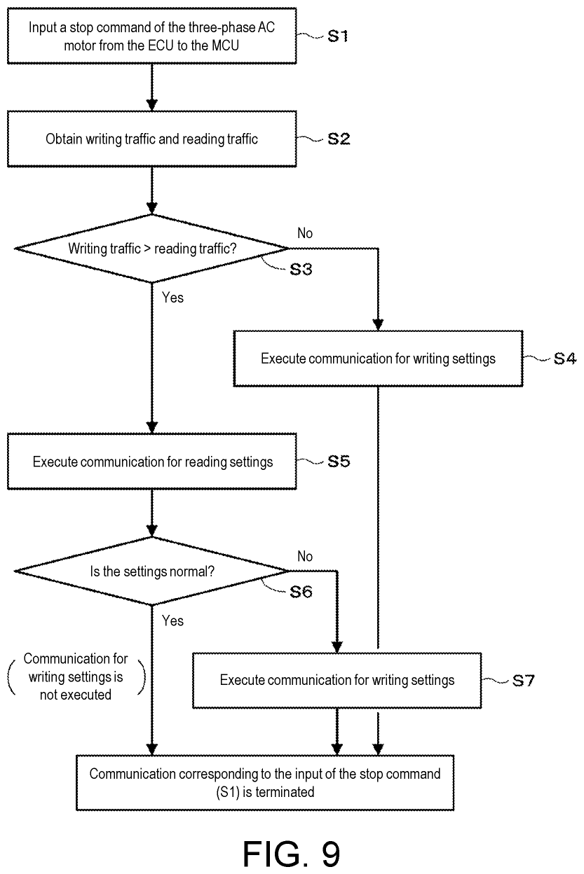

FIG. 7 is a diagram showing the functional configuration of the MCU 12 of the motor control device 10 according to the third embodiment, as an example of the specific configuration aspect of the control device according to the disclosure. FIG. 8A and FIG. 8B are diagrams showing the processing content of the motor control device 10 and the communication method in the motor control device according to the third embodiment, as examples of the specific configuration aspect of the control device and the communication method in the control device according to the disclosure. FIG. 9 is a flowchart showing the processing procedure of the motor control device 10 and the communication method in the motor control device according to the third embodiment.

The motor control device 10 according to the third embodiment of the disclosure includes the MCU 12 and the predriver 13 configuring at least a part of a circuit for controlling driving of a motor. The MCU 12 includes a communication timing judgment portion 121, judging whether or not a timing is to execute the communication between the MCU 12 and the predriver 13 and outputting a communication verification command when the timing is judged to be a timing to execute the communication between the MCU 12 and the predriver 13; a traffic comparison portion 123, comparing a traffic required to write settings of the predriver 13 (referred to as “writing traffic”) and a traffic required to read current settings of the predriver 13 (referred to as “reading traffic”) when the communication verification command is input, outputting a communication execution command when the reading traffic is heavier than the writing traffic, and outputting a reading execution command to read a content of the current settings of the predriver 13 when the reading traffic is less than the writing traffic; a setting content judgment portion 124, judging whether or not the content of the current settings of the predriver 13 is normal and outputting a communication execution command when the content of the current settings of the predriver 13 is abnormal; and a communication portion 122, executing the communication between the MCU 12 and the predriver 13 for reading the current settings of the predriver 13 when the reading execution command is input and executing the communication between the MCU 12 and the predriver 13 for writing the settings of the predriver 13 when the communication execution command is input.

Further, the communication method in the motor control device according to the third embodiment of the disclosure is a method executed by a motor control device including an MCU 12 and a predriver 13, the method includes: a step of judging whether or not a timing is to execute the communication between the MCU 12 and the predriver 13; steps S2 and S3 of comparing a traffic required to write settings of the predriver 13 (referred to as “writing traffic”) and a traffic required to read current settings of the predriver 13 (referred to as “reading traffic”) when the timing is judged to be a timing to execute the communication between the MCU 12 and the predriver 13 (step S1); a step S4 of executing the communication between the MCU 12 and the predriver 13 for writing the settings of the predriver 13 when the reading traffic is heavier than the writing traffic (step S3: No); a step S5 of executing the communication between the MCU 12 and the predriver 13 for reading the current settings of the predriver 13 when the reading traffic is less than the writing traffic (step S3: Yes); a step S6 of judging whether or not a content of the read current settings of the predriver 13 are normal; and a step S7 of executing the communication between the MCU 12 and the predriver 13 for writing the settings of the predriver 13 when the content of the read current settings of the predriver 13 is abnormal (step S6: No).

In this embodiment, the timing of executing communication is limited as in the first embodiment, and unnecessary communication with heavy traffic is prohibited as in the second embodiment, the configuration and concept related to the limitation of the timing of executing communication are common to those in the first embodiment; the configuration and concept related to the prohibition of unnecessary communication with heavy traffic are common to those in the second embodiment; and the description is omitted for the common and equivalent configurations and concepts with those of the first embodiment and the second embodiment.

In this embodiment, at the timing when the stop command (specifically, an electrical signal corresponding to the stop command) of the three-phase AC motor 20 is input from the ECU 30, which is the upper control device of the MCU 12 and the predriver 13, to the MCU 12, verification is performed to judge whether or not the communication between the MCU 12 and the predriver 13 is to be executed, and based on the results of the verification, the communication between the MCU 12 and the predriver 13 is executed as necessary to execute writing of the settings from the MCU 12 to the predriver 13.

Specifically, first, when the stop command of the three-phase AC motor 20 is input from the ECU 30 to the communication timing judgment portion 121 of the MCU 12 (step S1), a communication verification command is output from the communication timing judgment portion 121 and input to the traffic comparison portion 123 of the MCU 12, and the traffic comparison portion 123 obtains the traffic required to write the settings of the predriver 13 (i.e., writing traffic) and the traffic required to read the current settings (register) of the predriver 13 (i.e., reading traffic) (step S1).

Regarding the process of step S1, the timing at which the communication verification command is output (in other words, the trigger; accordingly, the timing to execute the communication between the MCU 12 and the predriver 13 as necessary) is not limited to the timing when the stop command of the three-phase AC motor 20 is transmitted from the ECU 30, any timing that does not pose a problem even if electromagnetic wave noise accompanying communication is emitted may be used. Specifically, the output of the communication verification command may be executed at the timing that avoids the noise generated by the communication between the MCU 12 and the predriver 13 from competing with the noise generated by other factors. In other words, the output of the communication verification command is executed at a timing that does not overlap with a timing at which noise occurs due to a factor other than the communication between the MCU 12 and the predriver 13. That is, the communication timing judgment portion 121 of the MCU 12 judges a timing that does not overlap with a timing at which noise occurs due to a factor other than the communication between the MCU 12 and the predriver 13 as the timing to execute the communication between the MCU 12 and the predriver 13.

In this embodiment, while the three-phase AC motor 20 is driven, since the noise is generated with the predriver 13 as a factor, the output of the communication verification command (accordingly, the communication between the MCU 12 and the predriver 13) is not executed to avoid competing with the noise, and the output of the communication verification command is executed because there is no noise generated with the predriver 13 as a factor when the three-phase AC motor 20 is stopped. Then, the communication timing judgment portion 121 of the MCU 12 judges the timing at which the ECU 30 transmits the stop command of the three-phase AC motor 20 as the timing to output the verification command (accordingly, the communication between the MCU 12 and the predriver 13 is executed as necessary).

Also, when the circuit (in particular, a combination of the MCU 12 and an IC that executes communication with that MCU 12 (i.e., an IC corresponding to the predriver 13 in this embodiment)) controls other mechanism or equipment, at the timing that does not pose a problem even if electromagnetic wave noise accompanying communication is emitted corresponding to each of the mechanism or equipment to be controlled, that is, at the timing that avoids noise caused by the communication between the MCU 12 and the IC competing with noise caused by other factors, in other words, the output of the communication verification command (accordingly, the communication between the MCU 12 and the IC) is executed at a timing that does not overlap with a timing at which noise occurs due to a factor other than the communication between the MCU 12 and the IC.

Furthermore, regarding the process of step S2, similar to the configuration described in connection with the second embodiment above, the writing traffic and the reading traffic in the communication between the MCU 12 and the predriver 13, which are determined and grasped at the design stage of the motor control device 10, are stored in advance in, for example, the memory in the MCU 12, and as the process of step S2, the stored writing traffic and reading traffic may be read.

Next, the traffic comparison portion 123 of the MCU 12 compares the writing traffic and the reading traffic obtained in step S2 and judges whether or not the reading traffic is less than the writing traffic (step S3).

Regarding the process of step S3, similar to the configuration described in connection with the second embodiment above, the magnitude relationship between the writing traffic and the reading traffic in the communication between the MCU 12 and the predriver 13, which are determined and grasped at the design stage of the motor control device 10, is stored in advance in, for example, the memory in the MCU 12, and as the process of step S3, the stored magnitude relationship may be read. Based on this, the process of step S2 and the process of step S3 may be substantially executed as a single process.

Then, when the reading traffic is heavier than the writing traffic (step S3: No), the communication execution command is output from the traffic comparison portion 123 of the MCU 12 and input to the communication portion 122 of the MCU 12, and the communication portion 122 executes the communication between the MCU 12 and the predriver 13 to write the settings of the predriver 13 (step S4). As a result, the communication between the MCU 12 and the predriver 13 corresponding to the input of one stop command (step S1) is terminated. Then, the communication between the MCU 12 and the predriver 13 related to the writing of the settings of the predriver 13 is not executed until the ECU 30 transmits the next stop command of the three-phase AC motor 20 (after the ECU 30 transmits a drive command of the three-phase AC motor 20) (referring to FIG. 8A).

On the other hand, when the reading traffic is less than the writing traffic (step S3: Yes), the reading execution command is output from the traffic comparison portion 123 of the MCU 12 and input to the communication portion 122 of the MCU 12, and the communication portion 122 executes the communication between the MCU 12 and the predriver 13 to read the current settings of the predriver 13 (step S5). Then, the content of the read current settings of the predriver 13 is transmitted to the setting content judgment portion 124 of the MCU 12.

After that, the setting content judgment portion 124 of the MCU 12 judges whether or not the read setting content is normal (step S6). The setting content judgment portion 124, for example, judges the read setting content to be normal when the register value (specifically, 1 or 0) matches the value that should be set in the current situation and judges the read setting content to be abnormal when the register value does not match the value that should be set in the current situation.

Specifically, the setting content judgment portion 124 may, for example, judge whether or not the read setting content is normal based on whether or not the content set for the predriver 13 when the power supply is turned on is retained as the same. It should be noted that when a malfunction or error occurs in the predriver 13, the content set for the predriver 13 when power supply is turned on changes. For example, when the power supply voltage of the predriver 13 fluctuates while the power supply voltage of the MCU 12 is not abnormal, the content set for the predriver 13 when the power supply is turned on is reset and changed by resetting the predriver 13.

In addition, based on a comparison with the proper content (in other words, content that should be set) at each time point when the system is operating, it may be judged whether or not the read setting content is normal.

Then, when the read setting content is abnormal (step S6: No), the communication execution command is output from the setting content judgment portion 124 of the MCU 12 and input to the communication portion 122 of the MCU 12, and the communication portion 122 executes the communication between the MCU 12 and the predriver 13 to write the settings of the predriver 13 (step S7). As a result, the communication between the MCU 12 and the predriver 13 corresponding to the input of one stop command (step S1) is terminated. Then, the communication between the MCU 12 and the predriver 13 related to the writing of the settings of the predriver 13 is not executed until the ECU 30 transmits the next stop command of the three-phase AC motor 20 (after the ECU 30 transmits a drive command of the three-phase AC motor 20) (referring to FIG. 8B).

On the other hand, when the read setting content is normal (step S6: Yes), the communication between the MCU 12 and the predriver 13 for writing the settings of the predriver 13 is not executed, and the communication between the MCU 12 and the predriver 13 corresponding to the input of one stop command (step S1) is terminated. Then, the communication between the MCU 12 and the predriver 13 related to the writing of the settings of the predriver 13 is not executed until the ECU 30 transmits the next stop command of the three-phase AC motor 20 (after the ECU 30 transmits a drive command of the three-phase AC motor 20) (referring to FIG. 8B).

### Effect

By using the motor control device 10 and the communication method in the motor control device according to the embodiments (specifically, the first embodiment to the third embodiment), since the timing of executing communication is limited and unnecessary communication with heavy traffic is prohibited, the frequency of noise oscillation may be reduced and the circumstances in which noise oscillation occurs may be limited, thereby reducing noise oscillation caused by communication on the same system and reducing the occurrence of adverse effects on electronic equipment due to electromagnetic interference.

Although the embodiment of the disclosure has been described above, the specific configuration aspects of the disclosure are not limited to the above embodiment, and the disclosure also includes embodiments in which variations, changes, etc. are added to the above embodiments to the extent not departing from the spirit of the disclosure.

For example, in the above embodiment, although the motor control device 10 is configured as a mechanism for controlling the driving of the three-phase AC motor 20 mounted in the vehicle (in other words, the MCU 12 and the predriver 13 configure at least a part of the circuit for controlling the driving of the motor), and communication is executed between the MCU 12 and the predriver 13, object to be controlled by the device according to the disclosure is not limited to a motor, and the communication partner of the MCU 12 is not limited to the predriver 13. That is, the other party that communicates with the MCU 12 may be any type of IC.

Furthermore, in the above embodiment, although the MCU 12 and the predriver 13 (i.e., one IC) communicate with each other, the number of ICs that communicate with the MCU 12 is not limited to one, and may be two or more. When the number of ICs communicating with the MCU 12 is two or more, in the processes of steps S1 and S2 of the second embodiment and steps S2 and S3 of the third embodiment, the traffic is obtained for each IC of the communication partner of the MCU 12 (in addition, the writing traffic and the reading traffic stored in the memory in the MCU 12 may be read), and the traffic is compared (in addition, the magnitude relationship between the writing traffic and the reading traffic stored in the memory in the MCU 12 may be read).

Furthermore, in the above embodiment, although SPI communication is performed between the MCU 12 and the predriver 13, the type and standard of the communication executed between the MCU 12 and the predriver 13 is not limited to SPI communication, and other types and standards of communication may be executed between the MCU 12 and the predriver 13.

What is claimed is:

1. A control device, comprising an MCU and an IC, wherein the MCU comprises:
a communication timing judgment portion, judging whether or not a timing is to execute a communication between the MCU and the IC and outputting a communication execution command when the timing is judged to be a timing to execute the communication between the MCU and the IC; and
a communication portion, executing the communication between the MCU and the IC when the communication execution command is input,
wherein the communication timing judgment portion judges a timing that does not overlap with a timing at which noise occurs due to a factor other than the communication between the MCU and the IC as the timing to execute the communication between the MCU and the IC.

2. The control device according to claim 1, wherein the MCU and the IC configure at least a part of a circuit for controlling driving of a motor, and
the timing that does not overlap with the timing at which noise occurs due to the factor other than the communication between the MCU and the IC is a timing at which a stop command of the motor is input from an ECU, which is an upper control device of the MCU and the IC, to the communication timing judgment portion of the MCU.

3. A control device, comprising an MCU and an IC, wherein
the MCU comprises:
a traffic comparison portion, comparing a traffic required to write settings of the IC (referred to as “writing traffic”) and a traffic required to read current settings of the IC (referred to as “reading traffic”), outputting a communication execution command when the reading traffic is heavier than the writing traffic, and outputting a reading execution command to read a content of the current settings of the IC when the reading traffic is less than the writing traffic;
a setting content judgment portion, judging whether or not a content of the read current settings of the IC is normal and outputting a communication execution command when the content of the current settings of the IC is abnormal; and
a communication portion, executing a communication between the MCU and the IC for reading the current settings of the IC when the reading execution command is input and executing the communication between the MCU and the IC for writing the settings of the IC when the communication execution command is input.

4. The control device according to claim 3, wherein the MCU and the IC configure at least a part of a circuit for controlling driving of a motor.

5. A communication method in a control device, which is a method executed by a control device comprising an MCU and an IC, the method comprising:
a step of judging whether or not a timing is to execute a communication between the MCU and the IC; and
a step of executing the communication between the MCU and the IC when the timing is judged to be a timing to execute the communication between the MCU and the IC,
wherein a timing that does not overlap with a timing at which noise occurs due to a factor other than the communication between the MCU and the IC is judged as the timing to execute the communication between the MCU and the IC.

6. The communication method in the control device according to claim 5, wherein the MCU and the IC configure at least a part of a circuit for controlling driving of a motor, and
the timing that does not overlap with the timing at which noise occurs due to the factor other than the communication between the MCU and the IC is a timing at which a stop command of the motor is input from an ECU, which is an upper control device of the MCU and the IC, to the MCU.

7. A communication method in a control device, which is a method executed by a control device comprising an MCU and an IC, the method comprising:
a step of comparing a traffic required to write settings of the IC (referred to as “writing traffic”) and a traffic required to read current settings of the IC (referred to as “reading traffic”);
a step of executing a communication between the MCU and the IC for writing the settings of the IC when the reading traffic is heavier than the writing traffic;
a step of executing the communication between the MCU and the IC for reading the current settings of the IC when the reading traffic is less than the writing traffic;
a step of judging whether or not a content of the read current settings of the IC are normal; and
a step of executing the communication between the MCU and the IC for writing the settings of the IC when the content of the read current settings of the IC is abnormal.

8. The communication method in a control device according to claim 7, wherein the MCU and the IC configure at least a part of a circuit for controlling driving of a motor.
